(19) United States
(12) Patent Application Publication
(10) Pub. No.: US 2009/0218154 A1
(43) Pub. Date: Sep. 3, 2009

(54) MOTORIZED BICYCLE

(76) Inventor: Raymond YEE, Kitchener (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 12/395,824

(22) Filed: Mar. 2, 2009

Related U.S. Application Data
(60) Provisional application No. 61/032,680, filed on Feb. 29, 2008.

(51) Int. Cl. B62K 11/00

(52) U.S. Cl. 180/220

(57) ABSTRACT

The invention is directed at a power assist module for a bicycle comprising a power source; a motor, connected to the power source; an output drive gear, controlled by motor through gear reduction; a multi-geared hub, mounted on a wheel of the bicycle; and a motor drive system connecting the output drive gear with the multi-geared hub; wherein rotation of the output drive gear by the motor, causes the drive chain to rotate the hub, thereby rotating the wheel of the bicycle.

### CROSS REFERENCE TO RELATED APPLICATIONS

This application claims the benefit of priority of U.S. Provisional Patent Application No. 61/032,680 filed Feb. 29, 2008, which is incorporated herein by reference in its entirety.

### FIELD OF THE INVENTION

The present invention relates in general to electric powered bicycles, and more particularly to an electric powered bicycle having an improved efficiency over a wide speed range.

### BACKGROUND OF THE INVENTION

Bicycles have been a form of transportation for many years and in some countries, the main mode of transportation. In more recent times, bicycles have been equipped with means to reduce the amount of energy required by the rider to propel the bicycle, such as by adding electric drives. Prior art electric drives for bicycles can be divided into various categories such as a friction drive on the bicycle wheel; an electric through the pedal shaft to the rear wheel; an electric through the chain to the rear wheel; an electric drive through a freewheeling sprocket (chain or gear); a direct drive to the rear wheel; or a wheel hub motor.

The cheapest and simplest type of electric drive for a bicycle is a friction drive which is mounted on the front or rear tire however this system is inefficient.

Electric drives through the pedal shaft to the rear wheel are usually heavy, bulky gearboxes with electric motors attached. The disadvantage of this system is that a rider must pedal when the motor is in operation. Although the electric drive can be isolated from the rider, the rider must still pedal at the drive speed to augment driving force. Versions that allow the motor to drive the rear wheel without turning the pedals are available, but they require additional non-standard mechanisms, which increase the cost of the bicycle. A further disadvantage of this type of drive is that, in high gear, the pedal shaft turns at about one third of the speed of the rear wheel; therefore, the rotational speed of the motor must be reduced by a factor of about three times when driving through the pedal shaft. As the power from the motor is transmitted through the pedal shaft to the rear wheel has to be sped up again, to about three times the pedal shaft speed. Both the additional reduction and the subsequent acceleration add to friction losses and a loss in overall efficiency of the bicycle.

Another disadvantage of drives through the pedal shaft is that the bulky transmission and motor combination around the pedal shaft requires the battery to be relegated to a higher position on the bike frame, away from the center of the bicycle, causing balance problems.

A disadvantage of electric bicycles with drives through the chain to the rear wheel is that they do not allow multiple front sprockets. The drive gear, typically mounted after the front crank sprocket, shortens the flex length of the chain which can result in the chain wear and dislodging from the electric drive sprocket.

Direct electric drives to the rear wheel take many different forms, but one disadvantage common to all of them is that they require an additional drive chain and sprocket, or belt and pulley combination, in addition to the customary pedal chain and sprocket. Also, in order to pedal the bicycle efficiently when the motor is not in use, a ratcheting device (commonly called a “freewheel”) is required between the extra sprocket pulley and the rear wheel hub. Additional drives systems to the rear wheel are not multi-geared due to the fact that there is no room for the extra gears and left hand drive components are not common.

Wheel hub motors are similar to a normal bicycle hub with flanges including holes for spokes on each side and an axle through the center. However they are much larger in diameter and much heavier. When applied to the front wheel of a bicycle, they create a gyroscopic force that at high speeds makes the bicycle hard to steer and thereby dangerous in some conditions. When applied to either the front of rear wheel of the bicycle, wheel hub motors increase the polar moment of inertia significantly in both the vertical and horizontal planes. This is an undesirable characteristic from a handling and safety point of view.

It is, therefore, desirable to provide a novel motorized mode of transportation that overcomes at least one of the disadvantages of prior art electric and/or motorized bicycles.

### SUMMARY OF THE INVENTION

It is an object of the present invention to obviate or mitigate at least one disadvantage of previous motorized or electric bicycles.

Accordingly, the need exists for an electric powered bicycle that includes at least one of the following advantages. Firstly, one advantage is a simple, inexpensive multi-speed drive wheel that can be efficiently driven by a motor. Another advantage is a speed shifting apparatus that can be used to shift the multi-speed drive to increase torque multiplication as the bicycle begins to climb steeper hills such that when the hub shifts to larger reductions, the torque required from the motor to climb the hill is reduced and the efficiency increases. Another advantage of the invention is an increase in efficiency with a lighter bicycle. Another advantage of the invention is a drive arrangement that is independent of the bicycle drive where the rider can be assisted while pedaling at any speed or effort while the drive operates at an efficient range. Yet a further advantage is a low polar moment of inertia for the drive wheel so unassisted riding feels similar to a normal bicycle. Another advantage is a motor/drive unit and battery that can be retrofitted to an existing bicycle such that the battery can be in a position that is low and close to the center of the bicycle.

In a preferred embodiment, a brushless, direct current electric motor is used, but not installed to the wheel as the manufacturer intended. Instead, on a front drive embodiment, the motor is mounted to brackets that are, in turn, mounted to the fork of the bicycle, just forward of the frame. A conventional chain can then be operatively connected around the sprocket(s) to drive the standard internally geared hub in the front wheel. The difference in the size of the sprockets can be adjusted to obtain the desired top speed of the bicycle, depending on the highest gear ratio of the multi-speed hub chosen.

In another embodiment, such as a rear wheel drive embodiment, a freewheeling sprocket is added to the drive gear of the internally geared rear hub. The standard bicycle drive train is connected to the freewheeling sprocket while the motor drive turns the drive gear. This allows the motor to assist the rider with the motor speed synchronized to the rider. Since the drive freewheels when coasting, the motor offers almost no resistance to rotation when the power is turned off so that the bicycle can be pedaled with almost the same ease as a non-electric bicycle. Further, since the electric motor drives through a different sprocket than the rider, chain wear is greatly reduced.

In another embodiment, the gear selection is actuated by a standard rear derailleur mounted on the fork. Optionally, the drive gear can be changed to a multiple gear arrangement actuated by a standard bicycle front derailleur.

In yet another embodiment of this invention the electric motor drives an independent internal multi-geared hub on the rear wheel. The hub is coupled to the rear wheel by a sprocket attached to the hub of the rear wheel.

Turning to another embodiment of the invention, there is provided a power assist module for a bicycle comprising a power source; a motor, connected to the power source; a gear reduced output drive gear, controlled by motor; a multi-geared hub, mounted on a wheel of the bicycle; and a motor drive system connecting the output drive gear with the multi-geared hub; wherein rotation of the output drive gear by the motor, causes the drive chain to rotate the hub, thereby rotating the wheel of the bicycle.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a bicycle, exemplifying a first embodiment of the present invention with a multi-speed internally geared hub;

FIG. 2 is an illustration of a bicycle, exemplifying a second embodiment of the present invention viewed from the right side, utilizing a derailleur mechanism on the front multi-speed freewheel hub;

FIG. 2a is an illustration with variation of the second embodiment where multiple drive sprocket are used and selected with a common front derailleur;

FIGS. 3a and 3b are side views of a third embodiment of the present invention with an internal geared hub driving the rear wheel;

FIG. 3c is a top view of a portion of the power module assembly;

FIG. 4 is a view of a fourth embodiment where the motor drives the drive gear of the internally geared rear wheel hub while the conventional bicycle drive train drives a freewheeling gear attached to the drive gear of the internally geared rear wheel hub drive;

FIG. 5 is an illustration of the modified internally geared hub sprocket with an additional freewheeling gear;

FIG. 6a is a graph illustrating wheel thrust vs speed for multi-gear and fixed gear bicycles; and

FIG. 6b is a graph illustrating efficiency vs speed for multi-gear and fixed gear bicycles.

### DETAILED DESCRIPTION

The present invention is directed at an apparatus and method for adding an electric powered drive to a conventional pedal bicycle. An electric motor with gear selectable reduction is mounted to the drive portion of the hub, so that either the motor or the pedals, independently or in unison, can drive the bicycle. The use of standard readily available components, adaptability to all standard bicycles, improved efficiency over a wide range of speeds and an independent drive offers many advantages over current motorized electric bicycles.

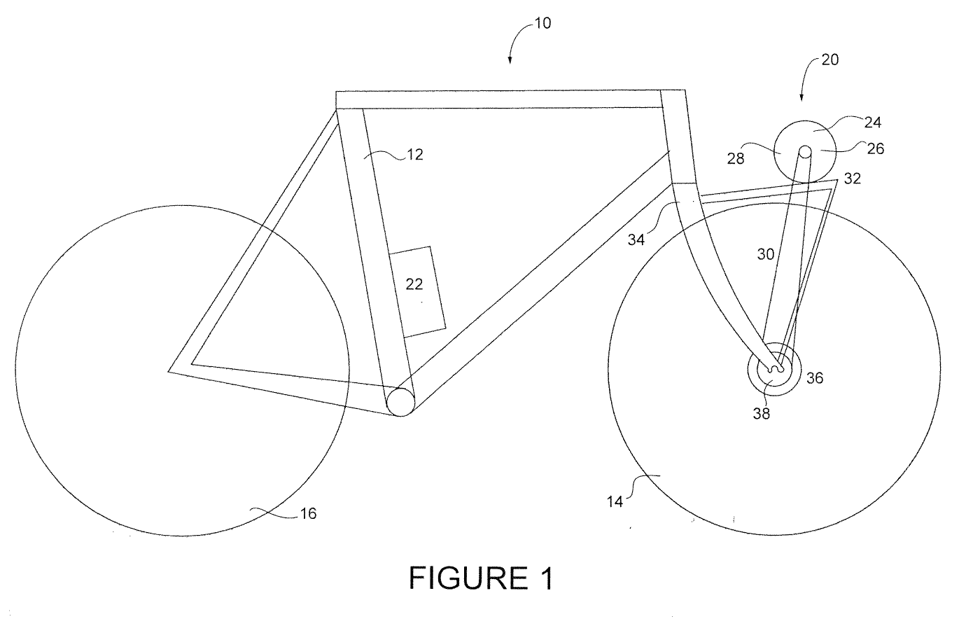

Turning to FIG. 1, a schematic diagram of a motorized form of transportation, in the form of a motorized bicycle is shown. The motorized bicycle 10 includes a frame 12 along with a pair of wheels, seen as a front wheel 14 and a rear wheel 16. The bicycle 10 will also include other parts such as, but not limited to, pedals or handlebars which are not shown.

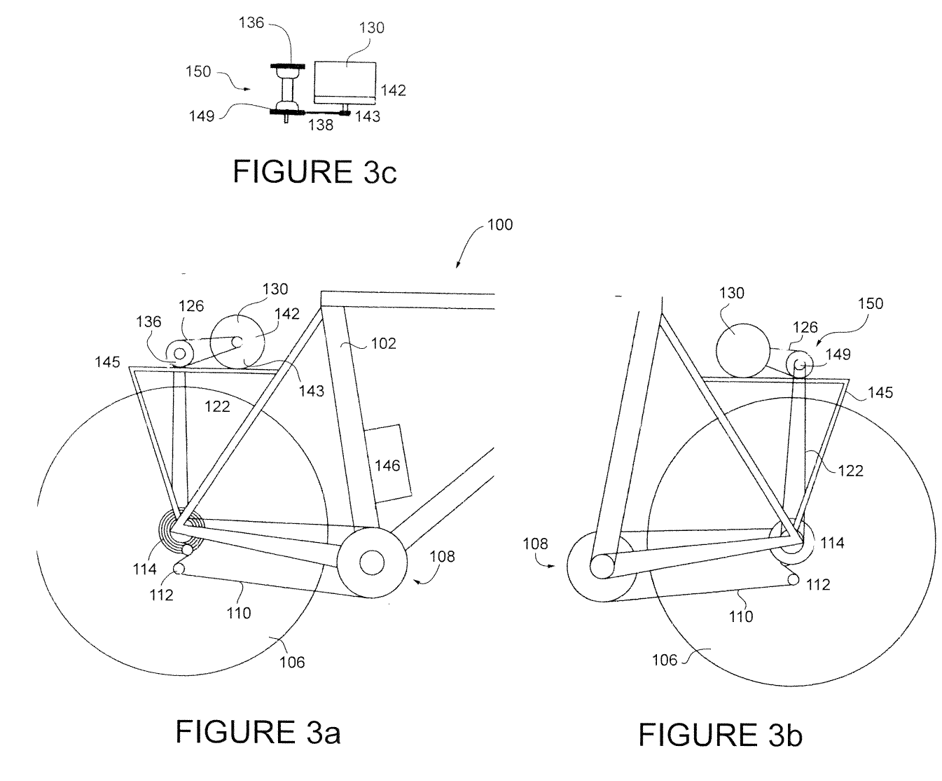

A power assist module 20 is located near the front wheel 14 of the bicycle 10 to provide an improved efficiency to the bicycle for a wide speed range and for improved hill climbing capability. In the current embodiment, the power assist module, or motor assembly, 20 comprises a battery module, such as a rechargeable battery, 22, mounted on frame 12 of the bicycle 10, an electric motor 24, gear reduction apparatus 26, an output drive gear 28, a drive chain 30 and a motor support bracket 32. The motor 24, gear reduction apparatus 26 and output drive gear 28 (shown in more detail with respect to FIG. 3c) are supported by the bracket 32 which is mounted to a fork portion 34 of the frame 12. Although not shown, it will be understood that power is supplied to the motor 24 by the battery 22 via a set of cables. Furthermore, the motor controller and throttle control are not shown as they will also be understood by one skilled in the art.

The drive train, or chain, 30 is attached to drive sprocket 28 and an internal multi-geared hub 36 (commonly used in rear bicycle wheel applications) with a driven sprocket 38. The drive chain 30 is controlled by the motor assembly 20 which also sets the tension on the drive chain 30. Alternatively, a separate standard chain tensioner can be used. The fork 34 is customizable or manufactured to meet the requirements of the internal multi-geared hub 36 and the support bracket 32.

The gear reduction apparatus 26 and the output drive gear 28 are customizable so that the motor assembly 20 can meet the requirements of any particular bicycle and rider. The battery module 22 is mounted to the frame 12 in a way that makes it easy to remove and replace. In the current embodiment, this means that it is easy to remove it in the forward direction and easily replaced in the rear direction. Alternatively, if the battery module 22 is mounted on the frame 12 near the front wheel 14, the battery 22 would be easy to remove in the rear direction and easily replaced in the forward direction.

In operation, when a rider wishes to use the bicycle, the motor assembly 20 is activated, or actuated, via a throttle switch. Upon activation, the motor 24 starts and rotates the output drive gear 28 which, in turn, rotates the multi-geared hub 36, via the drive chain 30. When the rider starts to pedal the bicycle, the power assist module 20 provides added torque to the pedaling process thereby reducing the amount of work required by the rider. As the rider continues to cycle, the rider may wish to change gears via the motor controller. When the gear is changed, the torque to speed ratio (based on the motor 20 and the hub 36) changes accordingly so that the rider is still provided extra boost.

Furthermore, the internal gear hub 36 increases torque multiplication as there is a higher motor input to output wheel rotation ratio as the bicycle begins to climb steep hills thereby reducing the torque required and increasing efficiency of the motor. In the preferred embodiment, a smaller and lighter motor and battery is used so that lighter bicycle components can also be used. This weight reduction leads to improved efficiency over current motorized bicycles.

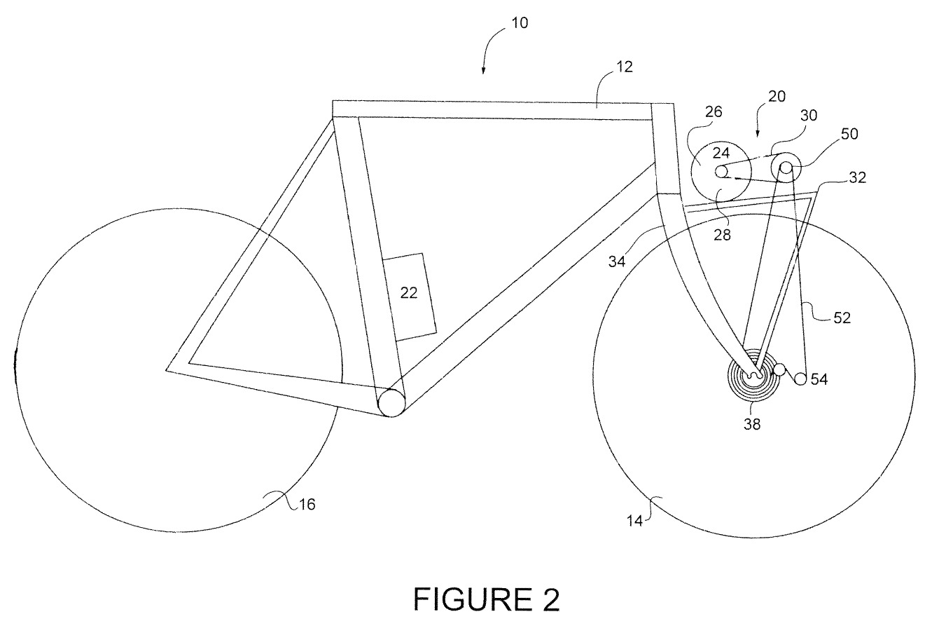

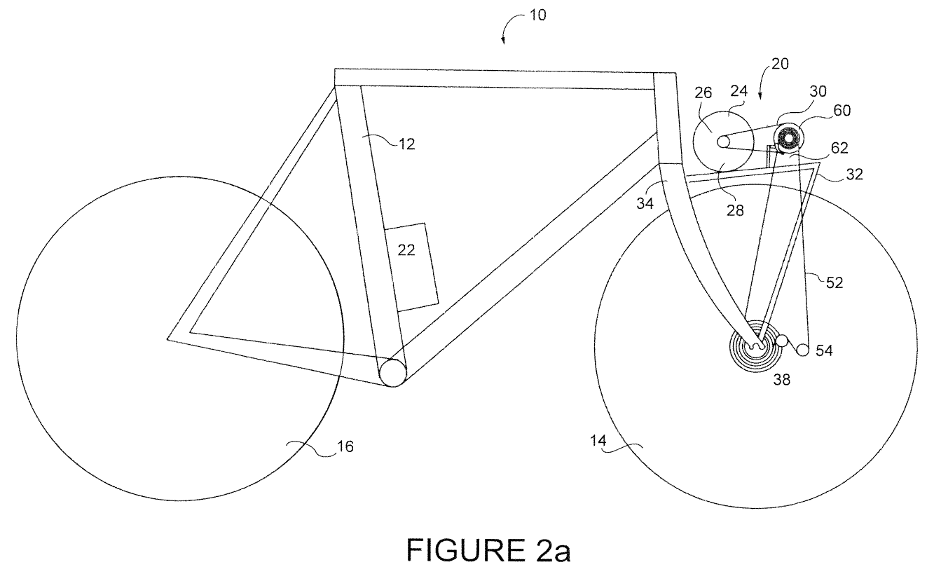

FIG. 2 is a schematic view of a second embodiment of a motorized bicycle. In this second embodiment, the bicycle has a different drive train setup than the embodiment of FIG. 1. As with FIG. 1, the bicycle 10 includes a frame 12 having a front wheel 14 and a rear wheel 16 mounted thereto. The power module assembly 20 includes the battery 22, the motor 24, the gear reduction apparatus 26 and the output drive gear 28. In this embodiment, the output drive gear 28 drives a gear reduction sprockets assembly 50 (having multiple gears) using the drive chain 30. An output gear of the gear reduction sprockets 50 drives a second chain, seen as drive chain 52. The drive chain 52 is engaged to the freewheel hub 38. In the current embodiment, the freewheel hub 38 can be a standard inexpensive component that is efficiently driven by the motor 24. Gear selection is controlled by a common rear bicycle derailleur 54.

When the motor assembly 20 is in operation, sprockets on the freewheeling hub 38 are rotated through its connection to the gear reduction sprockets assembly 50 to provide the additional torque to the rider. The fork 34 is customized or manufactured to handle the requirements of freewheel hub 38, derailleur 54, and motor support bracket 32.

FIG. 2a is a variant of FIG. 2 with a different gear sprockets assembly 50 is different. In this embodiment, a gear reduction sprockets assembly 60 contains multiple output gears and gear selection is controlled by a common front derailleur 62 to improve the range of gearing. Operation of the bicycle will be understood by one skilled in the art.

Turning to FIGS. 3a and 3b, opposite side views of a rear wheel of a further embodiment of a motorized bicycle are provided. FIG. 3a is a right hand side view while FIG. 3b is a left hand side wheel. In this embodiment, the bicycle 100 includes a frame 102 to which a rear wheel 106 is mounted. A gear 108 is also mounted to the frame 102 around which an individual chain 110 can be meshed. The chain 110 is meshed with the gear 108, a derailleur 112 and a rear free-wheel 114. A second drive chain 122 surrounds a gear from the freewheel 114 mounted to the left side of the hub of the rear wheel 106 at one end and is connected at a second end to a hub drive sprocket 149 of a multi-gear assembly 150. A further chain 126 is meshed to a hub drive sprocket 136 of the multi-gear assembly 150 and also to an output drive gear 143 of a power assist module. Along with the output drive gear 143 is a gear reduction apparatus 142 and a motor 130.

The apparatus rests on a support 145 which is mounted to the frame 102 of the bicycle 100. A battery 146 is also mounted to the frame 102 and is placed such that it is easily accessible for repair or replacement.

This embodiment offers a drive arrangement that is independent of the bicycle drive or chain system whereby the rider can be efficiently assisted by the drive regardless of the effort or speed the rider chooses. The rear wheel 106 has a low polar moment of inertia so unassisted riding feels similar to an unassisted bicycle.

A top view of the power assist module (which is mounted on the support bracket 145) is shown in FIG. 3c. As can be seen, the motor 130 is adjacent the gear reduction apparatus 142 which, in turn, is connected to the output drive gear 143. The chain 126 is meshed at one end to the output drive gear 143 and at a second end to the driven sprocket 149 of the multi-gear assembly 150. The multi-gear assembly 150 also includes the internal geared hub drive sprocket 136 which is attached via the drive chain 122 to the freewheel hub 114.

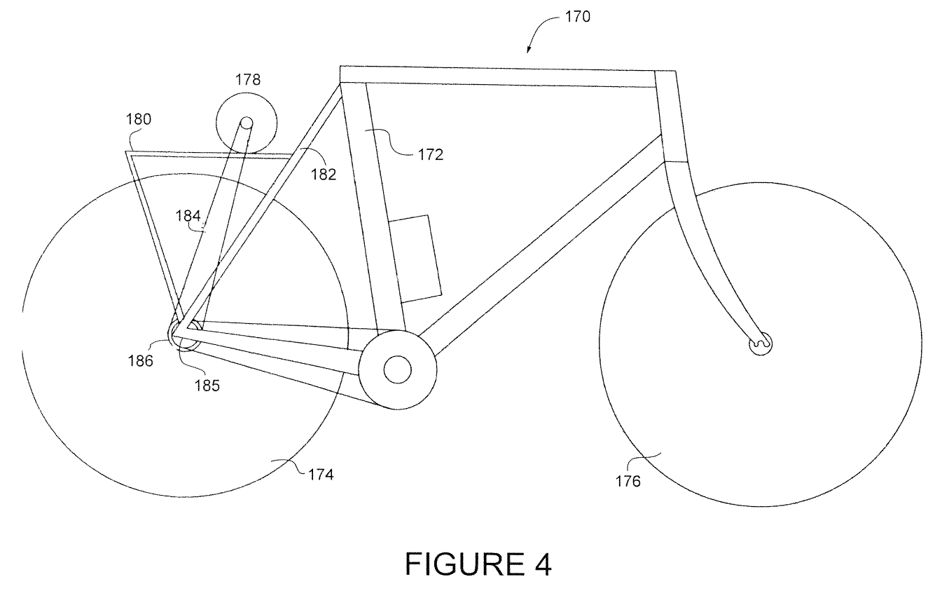

Turning to FIG. 4, a further embodiment of a motorized bicycle is shown. As before, the bicycle 170 includes a frame 172 on which a rear wheel 174 and a front wheel 176 are mounted.

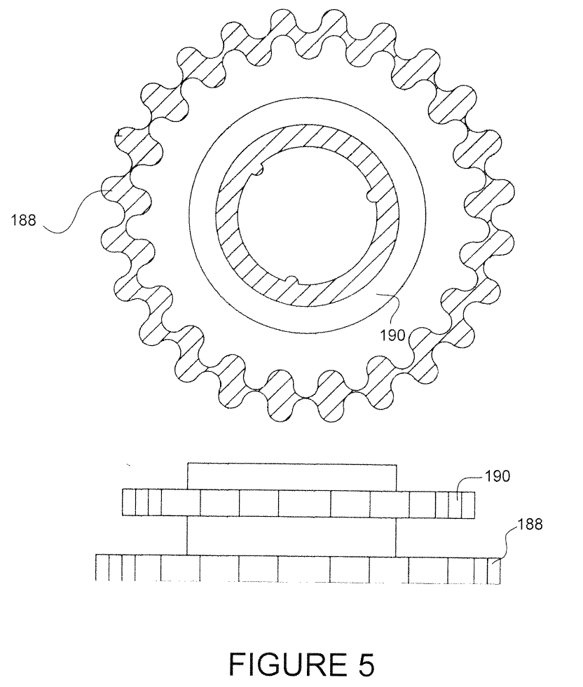

A power assist module 178 including a motor, gear reduction apparatus and output drive gear, mounted on a support bracket 180 (attached to a fork 182 of the frame 172). A drive chain 184 is connected to a drive sprocket 185 of an internal multi-gear hub assembly 186 and to the output drive gear. A schematic view of the drive sprocket 185 is shown in FIG. 5. Standard internally geared drive sprocket 188 includes a freewheeling sprocket 190.

If the motor does not have a freewheeling sprocket, then a double freewheeling sprocket is required. This allows the internally geared hub to be driven by the rider and/or the motor with gear selection fully utilized. However, if the rider chooses to assist while using the motor (or visa versa), the rider and motor must be synchronized. Thus the gearing of the motor and/or the freewheeling sprocket 190 should be chosen to rotate at a speed acceptable by the rider.

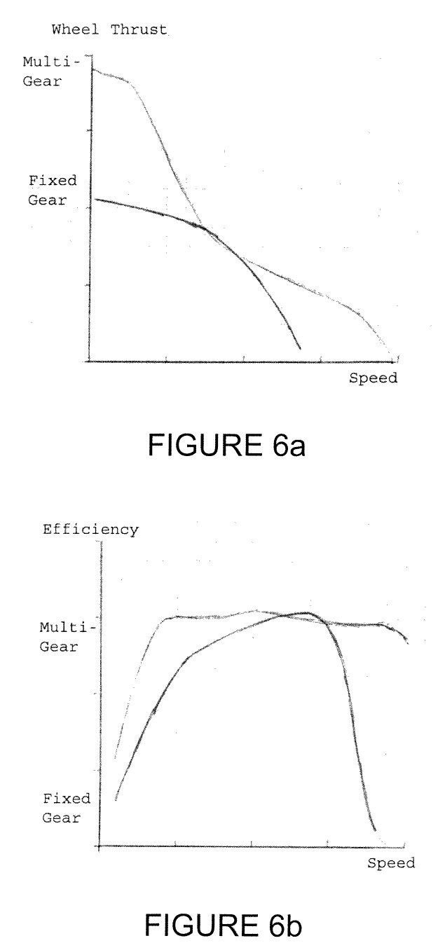

FIGS. 6a and 6b are graphs reflecting the advantages of the multi-gear bicycle versus a fixed gear bicycle. As can be seen in FIG. 6a, at most speeds, the wheel thrust of a multi-gear bicycle is greater than the wheel thrust for a fixed gear bicycle. With respect to FIG. 6b, it can be seen that at higher speeds, the efficiency of a multi-gear bicycle is greater than the efficiency of a fixed gear bicycle. Furthermore, the fixed gear has a very narrow efficiency speed range while the multi-gear drive train is almost always at peak efficiency.

In yet a further embodiment, the bicycle has at least one of the following advantages: 1) the motor is geared to and turns at the appropriate speed whereby the ratio can be easily customized to the requirements of the particular bicycle and rider; 2) the multi-speed hub can be operated to keep the motor speed up even when the bicycle is moving slowly, which provides the necessary torque and efficiency when climbing a hill; 3) with the multi-speed geared hub providing torque multiplication, a smaller, lighter motor is required and thus a smaller lighter battery is required to generate the same performance as a single speed drive; 4) the smaller, lighter battery and motor is more efficient to transport; 5) the gyroscopic effect of the added drive is minimal; 6) use of standard readily available components; 7) adaptability to all standard bicycles; and 8) the ability for the rider to pedal independent of the motor speed.

While the present invention has been illustrated by a description of the preferred embodiments and while these embodiments have been described in considerable detail in order to describe the best mode of practicing the invention, it is not the intention of the applicant to restrict or in any way limit the scope of the appended claims to such detail. For example, it is within the scope of the invention that the power assist module could be used in conjunction with other manually operated vehicles such as tricycles and the like.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A power assist module for a bicycle comprising:
a power source;
a motor, connected to the power source;
a gear reduced output drive gear, controlled by motor;
a multi-geared hub, mounted on a wheel of the bicycle; and
a motor drive system connecting the output drive gear with the multi-geared hub;
wherein rotation of the output drive gear by the motor, causes the drive chain to rotate the hub, thereby rotating the wheel of the bicycle.

2. The power assist module of claim 1 further comprising:
a sprockets assembly; and
the motor drive system including a wheel drive chain, connecting the sprockets assembly and the multi-geared hub; and
a motor drive chain connecting the output drive gear with the sprockets assembly.

3. The power assist module of claim 1 further comprising:
a support bracket mounted to a frame of the bicycle for supporting the motor and the output drive gear.

4. The power assist module of claim 1 further comprising:
a gear reduction apparatus located between the motor and the output drive gear.

5. The power assist module of claim 2 further comprising:
a derailleur, attached between the sprockets assembly and the hub for assisting in gearing.

6. The power assist module of claim 1 further comprising a freewheel assembly.

7. The power assist module of claim 6 wherein the freewheel assembly comprises:
a freewheel sprocket assembly; and
a drive sprocket and freewheel clutch.
